(19) United States
(12) Patent Application Publication
(10) Pub. No.: US 2025/0021959 A1
(43) Pub. Date: Jan. 16, 2025

(54) SYTSEMS AND METHODS FOR AUGMENTED-REALITY ASSISTED DETERMINATION OF MERCHANT COMPATIBILITY

(71) Applicant: Capital One Services, LLC, McLean, VA (US)

(72) Inventors: George BERGERON, Falls Church, VA (US); Christopher CRAWFORD, Midlothian, VA (US); Edward BARNES, Fairfax, VA (US)

(21) Appl. No.: 18/222,294

(22) Filed: Jul. 14, 2023

(51) Int. Cl. G06Q 20/32; G06Q 20/24; G06Q 20/26; G06T 19/00

(52) U.S. Cl. CPC G06Q 20/322; G06Q 20/24; G06Q 20/26; G06T 19/006

(57) ABSTRACT

Systems and methods for using an augmented-reality enabled user device to help users understand which merchants accept a predetermined group of payment methods are disclosed. A user may open a camera and point it at a merchant symbol. A user device application may determine what payment methods are accepted at the merchant and display such information as a virtual object on the display of a user device.

### FIELD OF THE DISCLOSURE

The present disclosure relates to systems and methods for providing an augmented-reality determination of merchant compatibility.

### BACKGROUND

Merchants often limit their accepted payment to only a few payment options, some of which may be more convenient, more private, or faster than others. But merchants differ in what options they offer, and it's rare for merchants to advertise their accepted payment methods. So it's often up to consumers to simply guess what payment methods are accepted at a certain merchant. Often, this guesswork means that consumers often don't know if their personal payment method will be accepted until they checkout. At worst, a merchant may not accept the user's payment method. This leads to frustration and wastes time on the user's part.

Even if merchants post their accepted payment methods, on their storefront or otherwise, users with poor eyesight or other accessibility issues may struggle in situations where discerning the available payment methods. This also leads to frustration and wasted time on the user's part, and potentially results lost sales for the merchants.

These and other deficiencies exist. Therefore, there is a need to provide an invention that overcome these deficiencies and allows for an effective and efficiency way to determine compatibility with merchant payment methods.

### SUMMARY OF THE DISCLOSURE

Aspects of the disclosed embodiments include systems and methods for enabling a user device processor to make an augmented-reality assisted determination of merchant payment compatibility.

In some aspects, the techniques described herein relate to a system for identifying an accepted payment method via augmented reality, the system including: a user device application configured to: activate a camera associated with a user device, detect, via the camera, one or more merchant symbols associated with one or more merchants, determine whether the one or more merchant symbols matches one or more known merchant symbols, identify a merchant based on a match between the one or more merchant symbols and the one or more known merchant symbols, determine whether the identified merchant accepts one or more predetermined payment methods, generate a determination message, wherein: the determination message indicates whether the one or more merchants accepts at least one of the one or more predetermined payment methods, and the determination message is a first virtual object, and display the determination message on a augmented reality enabled display associated with the user device.

In some aspects, the techniques described herein relate to a method for determining a payment terminal via augmented reality, the method including: activating, by a user device application, a camera associated with a user device; detecting, by the user device application via the camera, one or more merchant symbols associated with one or more merchants; determining, by the user device application, whether the one or more detected merchant symbols match one or more known merchant symbols; determining, by the user device application, whether the merchant accepts one or more predetermined payment methods; generating, by the user device application, a determination message, wherein: the determination message indicates whether the one or more merchants accepts any one of the one or more predetermined payment methods, and the determination message is a virtual object, and displaying, by the user device application, the determination message on an augmented reality enabled display associated with the user device.

In some aspects, the techniques described herein relate to a non-transitory computer readable medium containing computer executable instructions that, when executed by a device including a processor, configure the computer hardware arrangement to perform procedures including: activating a camera associated with a user device; detecting, via the camera, one or more merchant symbols associated with one or more merchants; determining whether the one or more detected merchant symbols match one or more known merchant symbols; identifying a merchant based on a match between the one or more merchant symbols and the one or more known merchant symbols, determining whether the identified merchant accepts one or more predetermined payment methods; generating a determination message, wherein: the determination message states at least whether the one or more merchants accepts any one of the one or more predetermined payment methods, and the determination message is a virtual object; and displaying the determination message on a augmented reality enabled display associated with the user device.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a diagram illustrating a system according to an exemplary embodiment.

FIG. 2 is a flowchart illustrating a method according to an exemplary embodiment.

FIG. 3 is a flowchart illustrating a method according to an exemplary embodiment.

FIG. 4 is a flowchart illustrating a method according to an exemplary embodiment.

FIG. 5 is a flowchart illustrating a method according to an exemplary embodiment.

FIG. 6 is a flowchart illustrating a method according to an exemplary embodiment. FIG. 7A and 7B are diagrams illustrating a method according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will recognize that the features, advantages and characteristics of any embodiment may be interchangeably combined with the features, advantages, and characteristics of any other embodiment.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The invention relates generally to systems and methods for providing an augmented-reality (AR) determination of merchant compatibility. The systems can include without limitation a user device, server, merchant processor, network, and database or data storage unit. The user device can have an AR-enabled application such as a mobile or web application. The application can be associated with a payment application such as a credit card application or debit card application.

Systems and methods of the present disclosure provide numerous advantages. With the AR-enabled app, the user can quickly determine if one or more merchants accepts the user's personal payment methods. This saves time and energy spent waiting to figure out a merchant's accepted payment methods until the arrive at the cash register. Furthermore, the application can be helpful for people with bad eyesight. AR applications can use the camera on a smartphone or tablet to magnify text, images, or objects in real time. This can be particularly helpful for people with low vision who have difficulty reading or seeing small details at checkout or storefronts from far away. The application can also identify objects in the user's environment and provide audio or visual cues to help the user find a merchant that accepts their personal payment methods. Thus, the present invention improves the technology of augmented reality devices.

In augmented reality, a virtual object is a computer-generated three-dimensional object that is superimposed onto the user's view of the real world through a display device, such as a smartphone or a head-mounted display. These virtual objects can range from simple 2D images to complex 3D models, and can be interactive or static. Virtual objects in augmented reality are typically anchored to a real-world location or surface using tracking technologies, such as GPS or visual markers, which allow the system to accurately place and track the virtual object in the user's view. This creates the illusion that the virtual object is actually present in the real world and can be interacted with by the user.

To interact with a virtual object, the user can initiate one or more of the following actions, including touch or gesture-based interaction, voice-based interaction, physical objection interaction, and spatial interaction. Using touch or gesture-based interaction, users can touch or make gestures on the display to interact with virtual objects. For example, they can tap on a virtual button to activate a feature, swipe to rotate an object, or use a pinch gesture to zoom in or out. Using voice-based interaction, users can use their voice to interact with virtual objects. For example, they can give voice commands to move or resize an object, or to trigger a specific action. Using physical object interaction, users can interact with virtual objects by using physical objects, such as a real-world controller or a prop designed for the specific AR application. Using spatial interaction, users can interact with virtual objects by moving around in physical space. For example, they can walk around a street to view a merchant from different angles or to trigger different actions. Any or all of these actions alone or in combination can be used in the example embodiments.

The virtual objects described herein can GPS data to guide users through real-world environments, overlaying directions and points of interest onto the user's view of the world through the display on the user device.

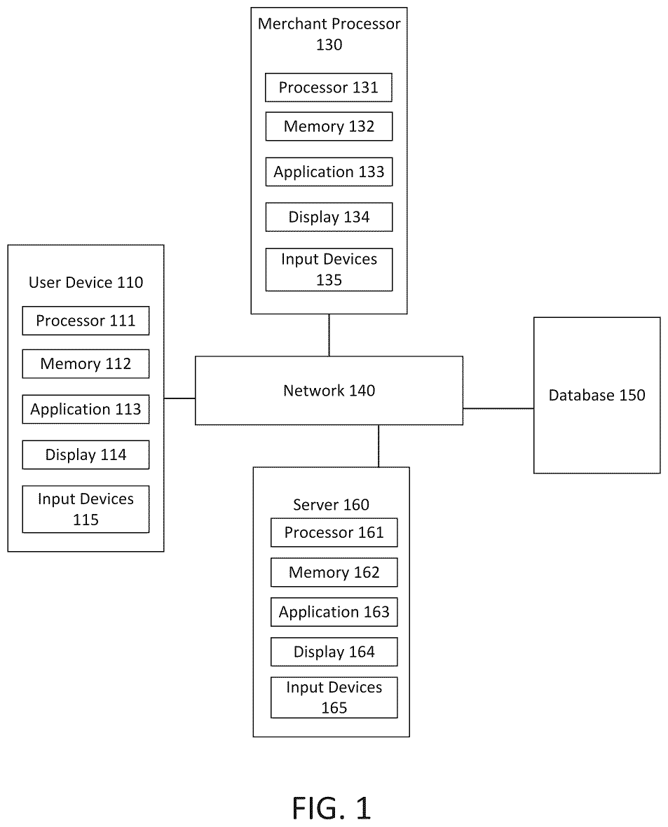

FIG. 1 illustrates a system 100 according to an exemplary embodiment. The system 100 may comprise a user device 110, a merchant processor 130, a network 140, a database 150, and a server 160. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

The user device 110 may include a processor 111, a memory 112, and an application 113. The processor 111 may be a processor, a microprocessor, or other processor, and the user device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's private data and financial account information.

The application 113 may comprise one or more software applications, such as a mobile application and a web browser, comprising instructions for execution on the user device 110. In some examples, the user device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described below. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein.

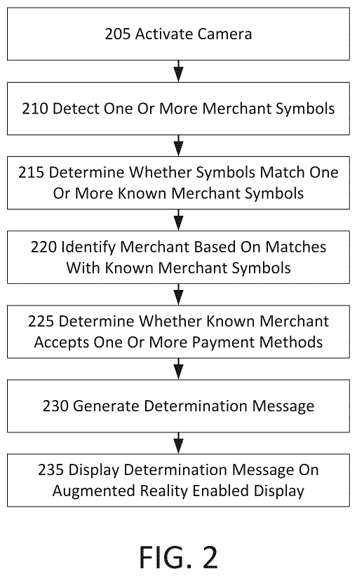

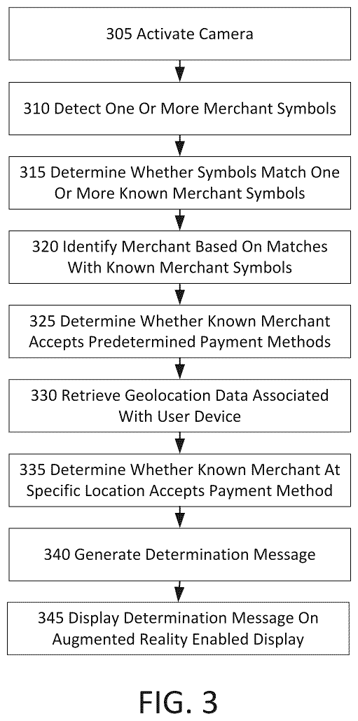

System 100 may include one or more contactless cards 120 which are further explained below with reference to FIG. 2 and FIG. 3. In some embodiments, contactless card 120 may be in wireless communication, utilizing near field communication (NFC) in an example, with user device 110.

System 100 may include a merchant processor 130. The merchant processor 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The merchant processor 130 may include a processor 131, a memory 132, and an application 133. The processor 131 may be a processor, a microprocessor, or other processor, and the merchant processor 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the merchant processor 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the merchant processor 130. In some examples, the merchant processor 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The merchant processor 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the merchant processor 130 that can be available and supported by the merchant processor 130, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network, and may be configured to connect the user device 110, the contactless card 120, the merchant processor 130, the database 150 and the server 160. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 160 or may be hosted externally of the server 160, such as by a server, by a cloud-based platform, or in any storage device that is in data communication with the server 160.

The server 160 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 160 may include a processor 161, a memory 162, and an application 163. The processor 161 may be a processor, a microprocessor, or other processor, and the server 160 may include one or more of these processors. The server 160 can be onsite, offsite, standalone, networked, online, or offline.

The processor 161 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 161 may be coupled to the memory 162. The memory 162 may be a read-only memory, write-once read-multiple memory or read/write memory, e.g., RAM, ROM, and EEPROM, and the server 160 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 162 may be configured to store one or more software applications, such as the application 163, and other data, such as user's private data and financial account information.

The application 163 may comprise one or more software applications comprising instructions for execution on the server 160. In some examples, the server 160 may execute one or more applications, such as software applications, that enable, for example, network communications with one or more components of the system 100, transmit and/or receive data, and perform the functions described herein. Upon execution by the processor 161, the application 163 may provide the functions described in this specification, specifically to execute and perform the steps and functions in the process flows described below. Such processes may be implemented in software, such as software modules, for execution by computers or other machines. The application 163 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 160 may further include a display 164 and input devices 165. The display 164 may be any type of device for presenting visual information such as a computer monitor, a flat panel display, and a mobile device screen, including liquid crystal displays, light-emitting diode displays, plasma panels, and cathode ray tube displays. The input devices 165 may include any device for entering information into the merchant processor 130 that is available and supported by the merchant processor 130, such as a touch-screen, keyboard, mouse, cursor-control device, touch-screen, microphone, digital camera, video recorder or camcorder. These devices may be used to enter information and interact with the software and other devices described herein.

In some examples, exemplary procedures in accordance with the present disclosure described herein can be performed by a processing arrangement and/or a computing arrangement (e.g., a computer hardware arrangement). Such processing and/or computing arrangement can be, for example entirely or a part of, or include, but not limited to, a computer and/or processor that can include, for example one or more microprocessors, and use instructions stored on a non-transitory computer-accessible medium (e.g., RAM, ROM, hard drive, or other storage device). For example, a computer-accessible medium can be part of the memory of the user device 110, the card 120, the merchant processor 130, the network 140, the database 150, and the server 160 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

FIG. 2 is a flowchart describing a method. The method can include without limitation a user device, a merchant processor, a server, a database or data storage unit, and a network. The merchant processor can be associated with a software application such as a mobile application or web application. These elements are discussed with further reference to FIG. 1. In FIG. 2, the processor performing the action can in some embodiments be associated with a user device application associated with the user device.

In action 205, the user device can activate a camera associated with the user device. For example, the user device may be a smartphone enabled with one or more cameras. In other embodiments, the user device can include augmented reality glasses and smart watch. The camera can be linked to a display on the user device. In some embodiments, the camera can be opened by the merchant processor via a merchant software application on the user device. As a nonlimiting example, a user may open the merchant application and from there open the camera. The camera and display are enabled to generate one or more virtual objects overlaid on top of the display to create an augmented reality (AR) display. Virtual objects are discussed with further reference above.

In action 210, the camera can detect one or more merchant symbols. As a nonlimiting example, this detection can be through Optical Character Recognition of Video (OCR-V) performed by a user device application associated with the user device. This involves extracting text from the frames of a video by analyzing the individual images in sequence. Merchant symbols can include any names, logos, trademarks, unique signifiers, or other symbols that are associated with the merchant itself and/or their accepted payment methods. Each merchant can have their own merchant symbol. In other embodiments, every merchant can display the same symbol to advertise their accepted payment methods.

Having detected one or more merchant symbols, in action 215 a user device application can determine whether the merchant symbols match any known merchant symbols. The user device application can check the detected merchant symbols against a database of known merchant symbols and determining if any of the symbols match in action 220. The user device application can be associated with the user device, the merchant processor, or the server. For example, the user device can detect the symbols, then transmit the detected symbols to either or both the merchant processor and server which can determine if the detected symbols match any known merchant symbols.

In action 225, a user device application can determine whether the known merchant accepted one or more payment methods. This action can be determined by the user device processor, the merchant processor, or the server. As a nonlimiting example, the user device application can inspect a database or data storage unit storing payment information for each of the one or more merchants associated with the one or more merchant symbols. This information in the database can be changed or updated according to the merchant, as merchants may need to update their accepted payment methods.

Having determined which merchants accept one or more predetermined payment methods, in action 230 the user device application can generate a determination message. The determination message can be a virtual object discussed with further reference above. Having generated the determination message, in action 235 the user device application can display the determination message on the user device display which can be enabled to support augmented reality including one or more virtual objects. It is understood that the process described in FIG. 2 can be performed multiple times for multiple merchants. For example, the camera may be de-activated then re-activated one or more times to detect merchant symbols across multiple instances.

FIG. 3 describes a method for determining payment methods with AR-enabled user devices. The method can include without limitation a user device, a merchant processor, a server, a database or data storage unit, and a network. The merchant processor can be associated with a software application such as a mobile application or web application. These elements are discussed with further reference to FIG. 1. In FIG. 3, the processor performing the action can in some embodiments be associated with a user device application associated with the user device.

In action 305, the user device can activate a camera associated with the user device. For example, the user device may be a smartphone enabled with one or more cameras. In other embodiments, the user device can include augmented reality glasses and smart watch. The camera can be linked to a display on the user device. In some embodiments, the camera can be opened by the merchant processor via a merchant software application on the user device. As a nonlimiting example, a user may open the merchant application and from there open the camera. The camera and display are enabled to generate one or more virtual objects overlaid on top of the display to create an augmented reality (AR) display. Virtual objects are discussed with further reference above.

In action 310, the camera can detect one or more merchant symbols. This detection can be through Optical Character Recognition of Video (OCR-V) performed by a user device application associated with the user device. This involves extracting text from the frames of a video by analyzing the individual images in sequence. Merchant symbols can include any names, logos, trademarks, unique signifier, or other symbols that are associated with the merchant itself and/or their accepted payment methods. Each merchant can have their own merchant symbol. In other embodiments, every merchant can display the same symbol to advertise their accepted payment methods.

Having detected one or more merchant symbols, in action 315 a user device application can determine whether the merchant symbols match any known merchant symbols. The user device application can check the detected merchant symbols against a database of known merchant symbols and determining if any of the symbols match in action 320. For example, the user device can detect the symbols, then transmit the detected symbols to either or both the merchant processor and server which can determine if the detected symbols match any known merchant symbols.

In action 325, a user device application can determine whether the known merchant accepted one or more payment methods. This action can be determined by the user device processor, the merchant processor, or the server. As a nonlimiting example, the user device application can inspect a database or data storage unit storing payment information for each of the one or more merchants associated with the one or more merchant symbols. This information in the database can be changed or updated according to the merchant, as merchants may need to update their accepted payment methods. In some instances, the camera may not detect any merchant symbols, or the user device application may determine that none of the merchant symbols have any payment methods on file. In such instances, the user device application can determine if other merchants not shown on camera but are nonetheless nearby accept any predetermined payment methods. To that end, in action 330 the user device application can retrieve one or more geolocation data associated with the user device. This action can be performed by the user device. The user device can be enabled with a Location Services API that is built into the smartphone's operating system. This API allows apps to access the smartphone's location data and use it for a variety of purposes, such as mapping, navigation, or location-based services. In example embodiments, the API can determine or retrieve geolocation data related to the user device.

Having retrieved the geolocation data, in action 335 the user device application can determine whether nearby merchants at any location nearby the user device accept any predetermined payment methods. Responsive to determining that a merchant at a nearby location accepts one or more predetermined payment methods, the user device application in action 340 can generate a determination message. The determination message can be a virtual object discussed with further reference above. Having generated the determination message, in action 345 the user device application can display the determination message on the user device display which can be enabled to support augmented reality including one or more virtual objects. It is understood that the process described in FIG. 3 can be performed multiple times for multiple merchants. For example, the camera may be de-activated then re-activated one or more times to detect merchant symbols across multiple instances.

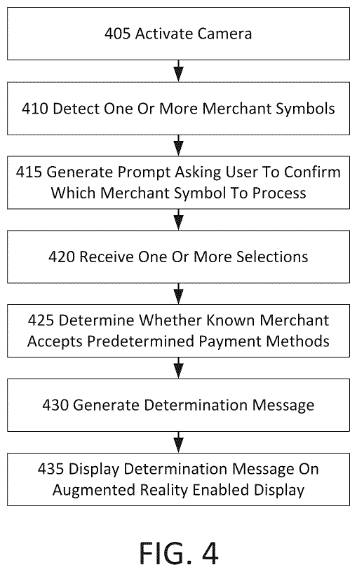

FIG. 4 describes a method for determining payment methods with AR-enabled user devices. The method can include without limitation a user device, a merchant processor, a server, a database or data storage unit, and a network. The merchant processor can be associated with a software application such as a mobile application or web application. These elements are discussed with further reference to FIG. 1. In FIG. 4, the processor performing the action can in some embodiments be associated with a user device application associated with the user device.

In action 405, the user device can activate a camera associated with the user device. For example, the user device may be a smartphone enabled with one or more cameras. In other embodiments, the user device can include augmented reality glasses and smart watch. The camera can be linked to a display on the user device. In some embodiments, the camera can be opened by the merchant processor via a merchant software application on the user device. As a nonlimiting example, a user may open the merchant application and from there open the camera. The camera and display are enabled to generate one or more virtual objects overlaid on top of the display to create an augmented reality (AR) display. Virtual objects are discussed with further reference above.

In action 410, the camera can detect one or more merchant symbols. This detection can be through Optical Character Recognition of Video (OCR-V) performed by a user device application associated with the user device. This involves extracting text from the frames of a video by analyzing the individual images in sequence. Merchant symbols can include any names, logos, trademarks, unique signifiers, or other symbols that are associated with the merchant itself and/or their accepted payment methods. Each merchant can have their own merchant symbol. In other embodiments, every merchant can display the same symbol to advertise their accepted payment methods.

Having detected one or more merchant symbols, in action 415 the user device application can generate a prompt asking the user to confirm which symbol to process. This action can be especially useful when the user is faced with many merchant options but would like to know information about one merchant specifically. In some embodiments, the user can tap or otherwise select a merchant symbol that is currently on their display. Thus, the user can select which merchant they want to learn more about. This prevents the screen from flooding with too many prompts, virtual objects, or other information. This is especially useful where the camera would detect many merchants at a shopping mall or particularly busy street. The user device application can receive one or more selections from the user in action 420.

In action 425, a user device application can determine whether the known merchant accepted one or more payment methods. This action can be determined by the user device processor, the merchant processor, or the server. As a nonlimiting example, the user device application can inspect a database or data storage unit storing payment information for each of the one or more merchants associated with the one or more merchant symbols. This information in the database can be changed or updated according to the merchant, as merchants may need to update their accepted payment methods. Having determined which merchants accept one or more predetermined payment methods, in action 430 the user device application can generate a determination message. The determination message can be a virtual object discussed with further reference above.

Having generated the determination message, in action 435 the user device application can display the determination message on the user device display which can be enabled to support augmented reality including one or more virtual objects. It is understood that the process described in FIG. 4 can be performed multiple times for multiple merchants. For example, the camera may be de-activated then re-activated one or more times to detect merchant symbols across multiple instances.

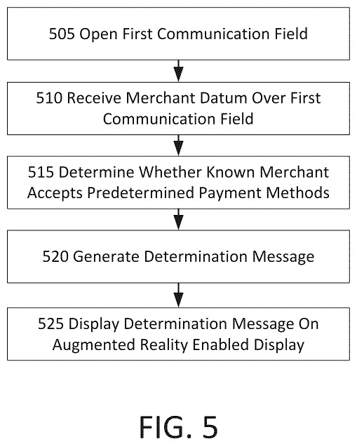

FIG. 5 describes a method for determining payment methods with AR-enabled user devices. The method can include without limitation a user device, a merchant processor, a server, a database or data storage unit, and a network. For example, the user device may be a smartphone enabled with one or more cameras. In other embodiments, the user device can include augmented reality glasses and smart watch. The merchant processor can be associated with a software application such as a mobile application or web application. These elements are discussed with further reference to FIG. 1. In FIG. 5, the processor performing the action can in some embodiments be associated with a user device application associated with the user device.

To avoid going into a store to find out what payment methods that the store accepts, the user can tap their user device to an NFC tag at or near the storefront. The information gathered from the NFC tag tells the user device what payment methods are accepted. Generally, NFC is the transmission of data through electromagnetic radio fields which enable two or more devices to communicate with each other without touching. NFC operates at 13.56 MHz on ISO/IEC 18000-3 air interface and at rates ranging from 106 kbit/s to 424 kbit/s. When two NFC-enabled devices are placed within a very small distances (e.g. a few centimeters), they can perform a transaction of information. NFC is beneficial to consumer transactions because it allows for near instantaneous reading of information. The receiving device reads the transmitted data the instant that it is sent. Therefore, human error is greatly reduced. Additionally, NFC reduces the time need to read a card. Rather than swipe a card through a reader, a consumer can simply touch the card or user device to an NFC enabled reader. Additionally, NFC reduces the risk of interference from fraudulent parties. Because NFC devices may communicate only over a very short distance, it is extremely difficult to intercept the information being sent between the devices.

Some examples of NFC communication include NFC card emulation where smartphones act like smart cards allowing users to perform transactions such as payment. As another example, NFC reader/writer communication allows devices to read information stored on NFC tags embedded into labels or smart posters. As another example, NFC peer-to-peer communication allows two NFC-enabled devices to communicate with each other to exchange information. These exemplary NFC actions can be used in conjunction with the systems and methods described herein.

NFC standards cover communications protocols and data exchange formats, and are based on existing RFID standards including ISO/IEC 14443 and FeliCa. The standards include ISO/IEC 18092 and those defined by the NFC Forum.

In action 505, the user device can open a first communication field. This action can be performed by a user device application associated with the user device. In FIG. 5, the processor performing the action can in some embodiments be associated with a user device application and/or processor associated with the user device.

In some embodiments, this action can be prompted by the user device coming within close proximity to an NFC tag, or it can be prompted manually by the user through the user device. Having opened the communication field, in action 510 the user device can receive one or more merchant datum over the first communication field. The merchant datum can include without limitation information concerning the payment methods accepted or not accepted by the merchant associated with the merchant datum. Having received the merchant datum, in action 515 a user device application can determine whether the known merchant accepted one or more payment methods. This action can also be determined by the user device processor, the merchant processor, or the server. As a nonlimiting example, the user device application can inspect a database or data storage unit storing payment information for each of the one or more merchants associated with the one or more merchant symbols. This information in the database can be changed or updated according to the merchant, as merchants may need to update their accepted payment methods. Having determined which merchants accept one or more predetermined payment methods, in action 520 the user device application can generate a determination message. This action can also be determined by the user device processor, the merchant processor, or the server. The determination message can be a virtual object discussed with further reference above. Having generated the determination message, in action 525 the user device application can display the determination message on the user device display which can be enabled to support augmented reality including one or more virtual objects. It is understood that the process described in FIG. 5 can be performed multiple times for multiple merchants.

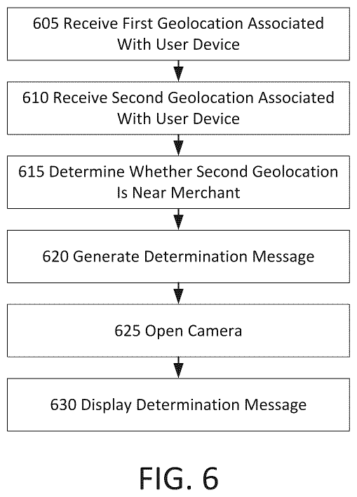

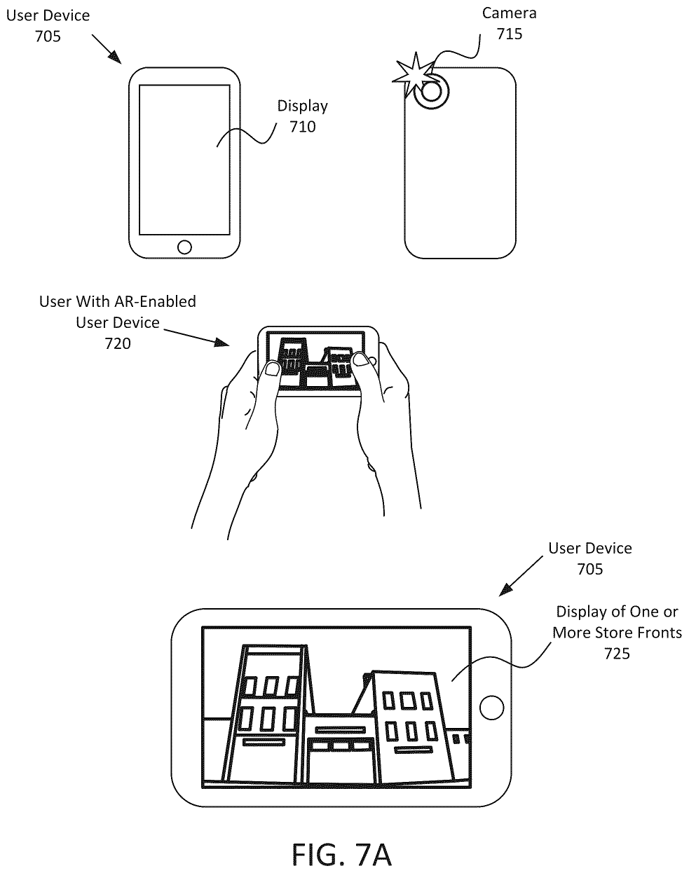

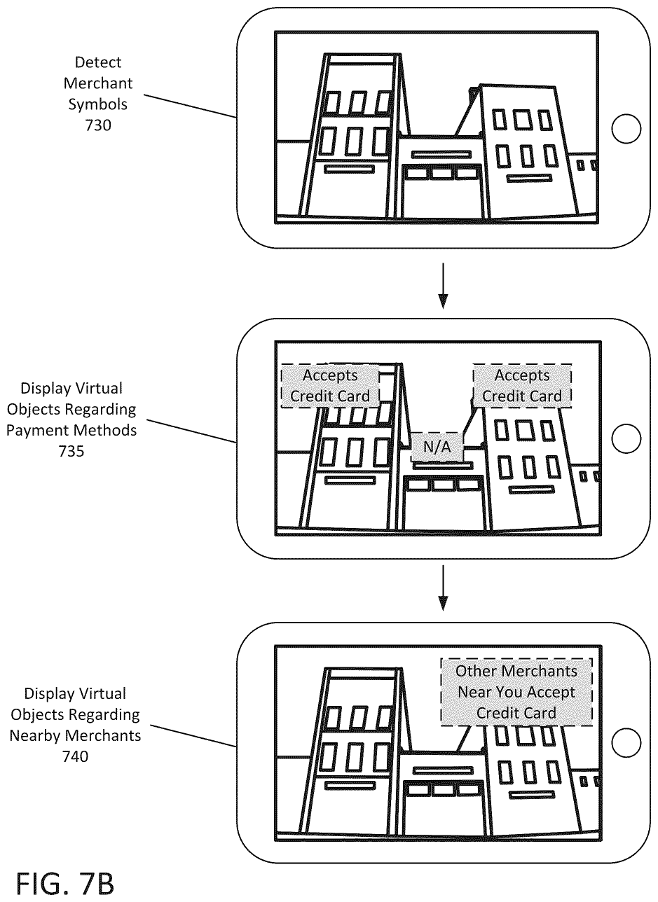

FIG. 6 describes a method for determining payment methods with AR-enabled user devices. In FIG. 6, the processor performing the action can in some embodiments be associated with a user device application associated with the user device.

In some instances, a user may be walking from one location to another. For example, a user may be walking down a street with several merchants. A user device application can receive the user's first location and second location, and determine if the user is heading towards a merchant that accepts one or more predetermined payment methods. This process is especially helpful when the user wants to check the accepted payment methods of a merchant that is not in view but that the user is nonetheless approaching. For example, a merchant may be right around the corner or just over a hill.

In action 605, the user device application receives a first geolocation associated with the user device. This action can also be determined by the user device processor, the merchant processor, or the server. For example, the user device may be a smartphone enabled with one or more cameras. In other embodiments, the user device can include augmented reality glasses and smart watch. The user device can be enabled with a Location Services API that is built into the smartphone's operating system. This API allows apps to access the smartphone's location data and use it for a variety of purposes, such as mapping, navigation, or location-based services. In the example embodiments, the API can determine or retrieve geolocation data related to the user device. After a predetermined time period, in action 610 the user device application can receive a second geolocation associated with the user device, and in action 615 determine whether the user is headed towards a nearby merchant. This determination can be made by comparing the users first location, second location, and the location of the merchant retrieved from a data base, data storage unit, or by a server. In other embodiments, the process can determine if the one or more merchants is sufficiently close to the user. Upon determining that the user is heading towards a nearby merchant, the user device application can retrieve the predetermined merchant payment methods from a database, data storage unit, or server. Having retrieved the payment methods, in action 620 the user device application can generate a determination message. The user device application can be associated with the user device. The determination message can be a virtual object discussed with further reference above. In action 625, the user device can activate a camera associated with the user device. For example, the user device may be a smartphone enabled with one or more cameras. The camera can be linked to a display on the user device. In some embodiments, the camera can be opened by the merchant processor via a merchant software application on the user device. As a nonlimiting example, a user may open the merchant application and from there open the camera. The camera and display are enabled to generate one or more virtual objects overlaid on top of the display to create an augmented reality (AR) display. In other embodiments, the user device application can prompt the user to open an application through which the user can open the AR-enable display. In other embodiments, the user device application can send the user device a short message service (SMS), multimedia messaging service (MMS), or a push notification. Having generated the determination message, in action 630 the user device application can display the determination message on the user device display which can be enabled to support augmented reality including one or more virtual objects. It is understood that the process described in FIG. 6 can be performed multiple times for multiple merchants.

FIG. 7A and 7B illustrate a user device with an AR-enabled display. In FIG. 7A, the user can hold the user device 705 configured with a camera 715 and display 710. For example, the user device may be a smartphone enabled with one or more cameras. In other embodiments, the user device can include augmented reality glasses and smart watch.

In an exemplary embodiment, the camera 715 is pointed at a row of merchants with store fronts 725 and displaying them on the user device 705. In other embodiments, the camera 715 may be pointed at one or more merchants in a mall; strip mall; food court; or other location with any number of merchants. The user device can activate a camera associated with the user device. For example, the user device may be a smartphone enabled with one or more cameras. The camera can be linked to a display on the user device. In some embodiments, the camera can be opened by the merchant processor via a merchant software application on the user device. As a nonlimiting example, a user may open the merchant application and from there open the camera. The camera and display are enabled to generate one or more virtual objects overlaid on top of the display to create an augmented reality (AR) display. Virtual objects are discussed with further reference above.

Having been pointed towards one or more merchants, in action 730 the camera can detect one or more merchant symbols. This detection can be through Optical Character Recognition of Video (OCR-V) performed by a user device application associated with the user device. In FIGS. 7A and 7B, the processor performing the action can in some embodiments be associated with a processor associated with the user device.

This involves extracting text from the frames of a video by analyzing the individual images in sequence. Merchant symbols can include any names, logos, trademarks, unique signifiers, or other symbols that are associated with the merchant itself and/or their accepted payment methods. Each merchant can have their own merchant symbol. In other embodiments, every merchant can display the same symbol to advertise their accepted payment methods. Having detected one or more symbols, in action 735 the user device can display one or more virtual objects with information regarding the payment methods accepted at each merchant. For example, one of the virtual objects can say “Accepts Credit Card” or “Accept Mobile Pay.” In other example, the virtual object can say “N/A” or “No info” if the merchant does not release their predetermined payment methods. As the user continues to scan other merchants via photo or video, the display will update with more virtual objects regarding each new merchant. In action 740, the user device can display one or more objects regarding nearby merchants. These virtual objects can be generated based on one or more geolocation data of the user device and other merchants.

In some aspects, the techniques described herein relate to a system for identifying an accepted payment method via augmented reality, the system including: a user device application configured to: activate a camera associated with a user device, detect, via the camera, one or more merchant symbols associated with one or more merchants, determine whether the one or more merchant symbols matches one or more known merchant symbols, identify a merchant based on a match between the one or more merchant symbols and the one or more known merchant symbols, determine whether the identified merchant accepts one or more predetermined payment methods, generate a determination message, wherein: the determination message indicates whether the one or more merchants accepts at least one of the one or more predetermined payment methods, and the determination message is a first virtual object, and display the determination message on a augmented reality enabled display associated with the user device.

In some aspects, the techniques described herein relate to a system, wherein the system further includes a server, wherein the server is configured to: receive a merchant symbol from the user device application, retrieve a merchant list from a data storage unit, determine whether the one or more merchant symbols matches one or more known merchant symbols from the merchant list, identify a merchant based on a match between the one or more merchant symbols and the one or more known merchant symbols, and transmit a verification message to the user device application.

In some aspects, the techniques described herein relate to a system, wherein the server determines whether the one or more merchants accepts at least one of the one or more predetermined payment methods and transmits the determinations to the user device application.

In some aspects, the techniques described herein relate to a system, wherein the user device application is further configured to display multiple determination messages overlaid on top of the augmented reality enabled display.

In some aspects, the techniques described herein relate to a system, wherein the merchant symbols include at least one selected from the group of a name, logo, and unique signifier.

In some aspects, the techniques described herein relate to a system, wherein the user device application is further configured to: retrieve one or more geolocation data associated with the user device, and determine whether the merchant symbol associated with a merchant at a specific geolocation accepts one or more payment methods.

In some aspects, the techniques described herein relate to a system, wherein the user device application is further configured to: open a first communication field, and receive, over the first communication field from a merchant tag, a merchant datum, wherein the datum is associated at least with the payment methods accepted at the merchant.

In some aspects, the techniques described herein relate to a system, wherein the user device application is further configured to detect the one or more merchant symbols through a digital photograph or video of the merchant symbol.

In some aspects, the techniques described herein relate to a system, wherein the user device application is further configured to initiate, upon determining whether the merchant accepts one or more payment methods, a haptic feedback on the user device.

In some aspects, the techniques described herein relate to a system, wherein user device application is further configured to: generate, upon detecting multiple merchant symbols via the camera, a prompt on the display wherein the prompt asks the user to confirm which merchant symbol the user would like to process; receive, from the user interacting with the display, one or more selections associated with the one or more merchant symbols; determine whether the one or more symbols associated with the detected merchants match one or more merchants on record; and determine whether the merchant accepts one or more payment methods.

In some aspects, the techniques described herein relate to a system, wherein the user device application is further configured to, upon determining that there is no known merchant symbol associated with the merchant symbol, retrieve, one or more alternative payment information associated with the merchant, wherein the alternative payment information includes at least one selected from the group of acceptance of credit cards, acceptance of debit cards, or acceptance of cash.

In some aspects, the techniques described herein relate to a system, wherein the user device includes at least one selected from the group of a mobile device, augmented reality glasses, and smart watch.

In some aspects, the techniques described herein relate to a method for determining a payment terminal via augmented reality, the method including: activating, by a user device application, a camera associated with a user device; detecting, by the user device application via the camera, one or more merchant symbols associated with one or more merchants; determining, by the user device application, whether the one or more detected merchant symbols match one or more known merchant symbols; determining, by the user device application, whether the merchant accepts one or more predetermined payment methods; generating, by the user device application, a determination message, wherein: the determination message indicates whether the one or more merchants accepts any one of the one or more predetermined payment methods, and the determination message is a virtual object, and displaying, by the user device application, the determination message on an augmented reality enabled display associated with the user device.

In some aspects, the techniques described herein relate to a method, wherein the method further includes: opening a first communication field; and receiving, over the first communication field, a merchant datum, wherein the datum is associated at least with the payment methods accepted at the merchant.

In some aspects, the techniques described herein relate to a method, wherein the method further includes retrieving, by the user device application upon detecting one or more merchant symbols, one or more customer-provided data from a data storage unit, wherein the customer-provided data includes at least information associated with any accepted payment methods for the one more merchants associated with the one or more merchant symbols.

In some aspects, the techniques described herein relate to a method, wherein the method further includes: receiving, by the user device application, a first geolocation of the user device; receiving, by the user device application, a second geolocation of the user device, wherein the second geolocation is associated with an inside of a merchant store; determining, by the user device application, whether the merchant accepts one or more predetermined payment methods; generating, by the user device application, a determination message; and transmitting, by the user device application to the user device, a notification to the user device, the notification including at least a message announcing that a merchant associated with the merchant store that accepts one of the predetermined payment methods.

In some aspects, the techniques described herein relate to a method, wherein the method further includes: retrieving, upon determining that no merchant symbols match any merchants on record, one or more geolocation data from the user device; determining, by the user device application based on the geolocation data from the user device, where a nearest merchant on record is located; and displaying, by the user device application through the user device, a determination message, wherein the determination is overlaid on top of a display associated with the user device, wherein the determination display includes a message disclosing where the nearest merchant on record is located.

In some aspects, the techniques described herein relate to a method, wherein the method further includes: receiving, by the user device application prior to opening the camera, one or more geolocation data from the user device; determining, by the user device application, a location of the user device; determining, by the user device application, whether the location of the user device is sufficiently close to a merchant location; and transmitting, by the user device application upon determining that the user device is sufficiently close to a merchant location, a notification to the user device, the notification including at least a message announcing that a merchant that accepts one of the predetermined payment methods is nearby and a prompt to open the camera, wherein the prompt can be tapped via the display.

In some aspects, the techniques described herein relate to a method, wherein the notification consists of at least one selected from the group of a short message service (SMS), multimedia messaging service (MMS), or push notification.

In some aspects, the techniques described herein relate to a non-transitory computer readable medium containing computer executable instructions that, when executed by a device including a user device application, configure the computer hardware arrangement to perform procedures including: activating a camera associated with a user device; detecting, via the camera, one or more merchant symbols associated with one or more merchants; determining whether the one or more detected merchant symbols match one or more known merchant symbols; identifying a merchant based on a match between the one or more merchant symbols and the one or more known merchant symbols, determining whether the identified merchant accepts one or more predetermined payment methods; generating a determination message, wherein: the determination message states at least whether the one or more merchants accepts any one of the one or more predetermined payment methods, and the determination message is a virtual object; and displaying the determination message on a augmented reality enabled display associated with the user device.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A system for identifying an accepted payment method via augmented reality, the system comprising:
a user device application configured to:
activate a camera associated with a user device,
detect, via the camera, one or more merchant symbols associated with one or more merchants,
determine whether the one or more merchant symbols matches one or more known merchant symbols,
identify a merchant based on a match between the one or more merchant symbols and the one or more known merchant symbols,
determine whether the identified merchant accepts one or more predetermined payment methods,
generate a determination message, wherein:
the determination message indicates whether the one or more merchants accepts at least one of the one or more predetermined payment methods, and
the determination message is a first virtual object, and
display the determination message on an augmented reality enabled display associated with the user device.

2. The system of claim 1, wherein the system further comprises a server, wherein the server is configured to:
receive a merchant symbol from the user device application,
retrieve a merchant list from a data storage unit,
determine whether the one or more merchant symbols matches one or more known merchant symbols from the merchant list,
identify a merchant based on a match between the one or more merchant symbols and the one or more known merchant symbols, and
transmit a verification message to the user device application.

3. The system of claim 2, wherein the server determines whether the one or more merchants accepts at least one of the one or more predetermined payment methods and transmits the determinations to the user device application.

4. The system of claim 1, wherein the user device application is further configured to display multiple determination messages overlaid on top of the augmented reality enabled display.

5. The system of claim 1, wherein the merchant symbols comprise at least one selected from the group of a name, logo, and unique signifier.

6. The system of claim 1, wherein the user device application is further configured to:
retrieve one or more geolocation data associated with the user device, and
determine whether the merchant symbol associated with a merchant at a specific geolocation accepts one or more payment methods.

7. The system of claim 1, wherein the user device application is further configured to:
open a first communication field, and
receive, over the first communication field from a merchant tag, a merchant datum, wherein the datum is associated at least with the payment methods accepted at the merchant.

8. The system of claim 1, wherein the user device application is further configured to detect the one or more merchant symbols through a digital photograph or video of the merchant symbol.

9. The system of claim 1, wherein the user device application is further configured to initiate, upon determining whether the merchant accepts one or more payment methods, a haptic feedback on the user device.

10. The system of claim 1, wherein user device application is further configured to:
generate, upon detecting multiple merchant symbols via the camera, a prompt on the display wherein the prompt asks the user to confirm which merchant symbol the user would like to process;
receive, from the user interacting with the display, one or more selections associated with the one or more merchant symbols;
determine whether the one or more symbols associated with the detected merchants match one or more merchants on record; and
determine whether the merchant accepts one or more payment methods.

11. The system of claim 1, wherein the user device application is further configured to, upon determining that there is no known merchant symbol associated with the merchant symbol, retrieve, one or more alternative payment information associated with the merchant, wherein the alternative payment information comprises at least one selected from the group of acceptance of credit cards, acceptance of debit cards, or acceptance of cash.

12. The system of claim 1, wherein the user device comprises at least one selected from the group of a mobile device, augmented reality glasses, and smart watch.

13. A method for determining a payment terminal via augmented reality, the method comprising:
activating, by a user device application, a camera associated with a user device;
detecting, by the user device application via the camera, one or more merchant symbols associated with one or more merchants;
determining, by the user device application, whether the one or more detected merchant symbols match one or more known merchant symbols;
determining, by the user device application, whether the merchant accepts one or more predetermined payment methods;
generating, by the user device application, a determination message, wherein:
the determination message indicates whether the one or more merchants accepts any one of the one or more predetermined payment methods, and
the determination message is a virtual object, and
displaying, by the user device application, the determination message on an augmented reality enabled display associated with the user device.

14. The method of claim 13, wherein the method further comprises:
opening a first communication field; and
receiving, over the first communication field, a merchant datum, wherein the datum is associated at least with the payment methods accepted at the merchant.

15. The method of claim 13, wherein the method further comprises retrieving, by the user device application upon detecting one or more merchant symbols, one or more customer-provided data from a data storage unit, wherein the customer-provided data comprises at least information associated with any accepted payment methods for the one more merchants associated with the one or more merchant symbols.

16. The method of claim 13, wherein the method further comprises:
receiving, by the user device application, a first geolocation of the user device;
receiving, by the user device application, a second geolocation of the user device, wherein the second geolocation is associated with an inside of a merchant store;
determining, by the user device application, whether the merchant accepts one or more predetermined payment methods;
generating, by the user device application, a determination message; and
transmitting, by the user device application to the user device, a notification to the user device, the notification comprising at least a message announcing that a merchant associated with the merchant store that accepts one of the predetermined payment methods.

17. The method of claim 13, wherein the method further comprises:
retrieving, upon determining that no merchant symbols match any merchants on record, one or more geolocation data from the user device;
determining, by the user device application based on the geolocation data from the user device, where a nearest merchant on record is located; and
displaying, by the user device application through the user device, a determination message, wherein the determination is overlaid on top of a display associated with the user device, wherein the determination display comprises a message disclosing where the nearest merchant on record is located.

18. The method of claim 13, wherein the method further comprises:
receiving, by the user device application prior to opening the camera, one or more geolocation data from the user device;
determining, by the user device application, a location of the user device;
determining, by the user device application, whether the location of the user device is sufficiently close to a merchant location; and
transmitting, by the user device application upon determining that the user device is sufficiently close to a merchant location, a notification to the user device, the notification comprising at least a message announcing that a merchant that accepts one of the predetermined payment methods is nearby and a prompt to open the camera, wherein the prompt can be tapped via the display.

19. The method of claim 18, wherein the notification consists of at least one selected from the group of a short message service (SMS), multimedia messaging service (MMS), or push notification.

20. A non-transitory computer readable medium containing computer executable instructions that, when executed by a device comprising a user device application, configure the computer hardware arrangement to perform procedures comprising:
activating a camera associated with a user device;
detecting, via the camera, one or more merchant symbols associated with one or more merchants;
determining whether the one or more detected merchant symbols match one or more known merchant symbols;
identifying a merchant based on a match between the one or more merchant symbols and the one or more known merchant symbols,
determining whether the identified merchant accepts one or more predetermined payment methods;
generating a determination message, wherein:
the determination message states at least whether the one or more merchants accepts any one of the one or more predetermined payment methods, and
the determination message is a virtual object; and
displaying the determination message on an augmented reality enabled display associated with the user device.
